(19) United States
(12) Patent Application Publication
(10) Pub. No.: US 2012/0110321 A1
(43) Pub. Date: May 3, 2012

(54) DATA COMMUNICATION USING PORTABLE TERMINAL

(76) Inventors: Stephan Splitz, Karlsfeld (DE); Hermann Sterzinger, Baldham (DE); Helmut Scherzer, Tubingen (DE); Hans Josef Borgs, Holzkirchen (DE); Thorsten Urhahn, Ulm (DE)

(21) Appl. No.: 13/123,828

(22) PCT Filed: Oct. 13, 2009
(86) PCT No.: PCT/EP09/07351

§ 371 Date: Apr. 12, 2011

(30) Foreign Application Priority Data
Oct. 14, 2008 (DE) 10 2008 051 578.7

(51) Int. Cl. H04L 29/06

(52) U.S. Cl. 713/151

(57) ABSTRACT

In a method in a portable end device (10), data (70E) received from an external data processing apparatus (100) which are prepared according to a communication protocol stack and, in so doing, cryptographically secured according to a security protocol (32) are handled. According to the invention, the received data (70E) are, in so doing, handled in an unsecured data handling environment (14) of the end device (10) according to communication protocols (22; 24; 26) of the communication protocol stack that are below the security protocol (32), and handled in a secured data handling environment (16) of the end device (10) at least according to the security protocol (32).

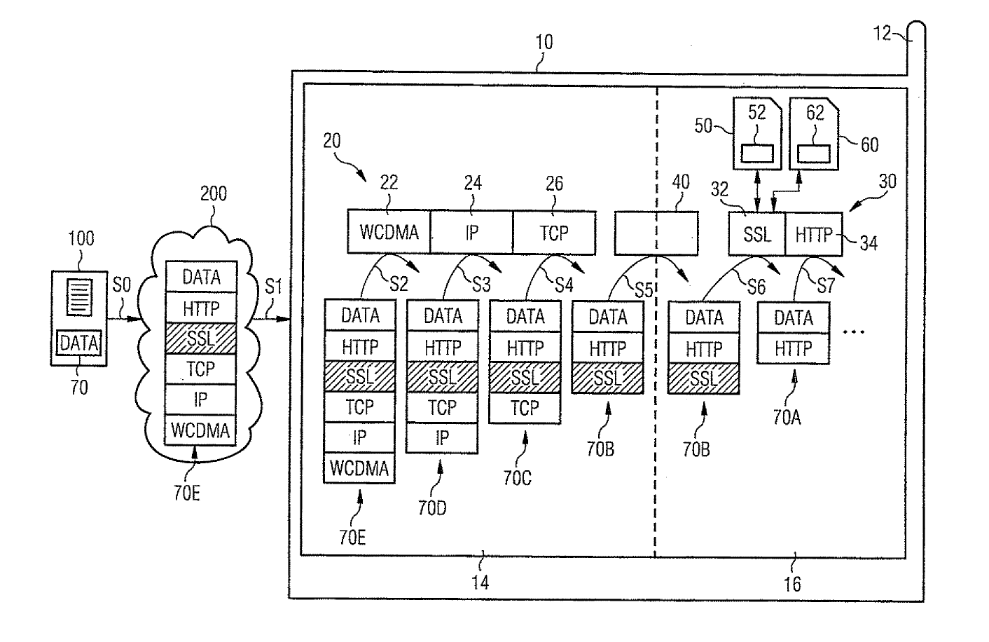

The present invention relates to a method for receiving and handling, on a portable end device, data that are prepared according to a communication protocol stack and, in so doing, cryptographically secured, and to an accordingly set up end device.

For such end devices, special processors are known with which a secured data handling environment and an unsecured data handling environment can be set up. In the secured data handling environment, security-relevant data and applications can be stored, handled and executed in secured fashion, whereby a control device likewise set up in the secured data handling environment controls a switchover between the secured data handling environment and the unsecured data handling environment. The unsecured data handling environment is normally managed by a usual operating system of the end device, while the secured data handling environment is managed by a separate, usually very compact security operating system. Such processors were developed e.g. by the company ARM (WO 2004/046934 A2; ARM White Paper “Trust-Zone: Integrated Hardware and Software Security, Enabling Trusted Computing in Embedded Systems”; T. Alves, D. Felton, July, 2004). Further, it is known to create similar secured data handling environments by means of different virtualization technologies.

However, operating systems of portable end devices, e.g. of mobile radio end devices, are normally not able to support secure data handling environments in the described form, i.e. for example a TrustZone technology, nor are the mentioned virtualization technologies for setting up secure data handling environments part of said operating systems. For this reason, security-relevant data and applications in connection with portable end devices are usually, e.g. in OTA methods (“Over The Air”, i.e. via the over-the-air interface) in mobile radio communication, stored on a secured portable data carrier integrable into the end device, e.g. on a (U)SIM mobile communication card, and executed there. However, the memory capacity and computing power of such portable data carriers is limited for design reasons, and accordingly makes a handling of security-relevant data on the data carrier inefficient. Further, such a procedure is unsuitable for a secured data transfer which relates to the end device itself, e.g. for the administration of the same.

Therefore, it is the object of the present invention to simplify a secured handling of data transferred in cryptographically secured fashion in a portable end device.

This object is achieved by a method and a portable end device having the features of the independent claims. Advantageous embodiments and developments are stated in the dependent claims.

In a method according to the invention, data received in a portable end device from an external data processing apparatus, which represent useful data that are prepared by said apparatus according to a communication protocol stack (i.e. provided with corresponding protocol data) and, in so doing, cryptographically secured according to a security protocol provided in the communication protocol stack, are handled such that the transferred useful data are cleared of the protocol information again. According to the invention, the received data are, in so doing, handled in an unsecured data handling environment of the end device according to communication protocols of the communication protocol stack that are below the security protocol, and handled in a secured data handling environment of the end device at least according to the security protocol.

An end device according to the invention comprises a data communication interface and an unsecured data handling environment and a secured data handling environment for unsecured and secured handling of data received via the data communication interface, respectively. According to the invention, the end device further comprises a data handling device in the unsecured data handling environment and a security data handling device in the secured data handling environment, whereby the data handling device is set up to handle data that are received via the data communication interface, prepared according to a communication protocol stack and, in so doing, cryptographically secured according to a security protocol, in the unsecured data handling environment according to the communication protocols below the security protocol, while the security data handling device is set up to handle the data at least according to the security protocol in the secured data handling environment.

In general, a data transfer between a portable end device, e.g. a mobile radio end device, and an external data processing apparatus, e.g. an Internet server or the like, proceeds via a communication network, e.g., the Internet and/or a mobile communication network, according to different network or communication protocols which make possible the data transfer on respectively different technical data transfer levels. Accordingly, the different communication protocols are associated with different layers of a so-called communication protocol stack, in which the communication protocols are arranged in a manner ordered with reference to the respective technical data transfer levels. Each layer, i.e. each communication protocol of a certain layer of the communication protocol stack, has associated therewith defined tasks within the framework of the total data transfer over the communication network. A communication protocol of one layer respectively consumes the services of a communication protocol of the layer below it and in its turn provides defined services to communication protocols of the layer above it. In connection with the known TCP/IP protocol stack according to the TCP/IP reference model, which combines communication protocols that are employed for data transfer over the Internet, there are distinguished for example four layers, which will be roughly sketched hereinafter: the Network Access Layer, the Internet or Network Layer, the Transport Layer and the Application Layer.

The communication protocols of the Network Access Layer regulate the point-to-point data transfer on the physical level. These are for example radio protocols such as WLAN or protocols employed in mobile radio communication, such as CDMA. The communication protocols of the Network Layer above, e.g. the IP protocol, are responsible for forwarding the data to be transferred and for routing within the communication network. The communication protocols of the Transport Layer, which is above the Network Layer, e.g. the TCP protocol, establish an end-to-end connection between the two participating communication partners, e.g. between the portable end device and the external data processing apparatus. The communication protocols of the uppermost layer, finally, of the Application Layer, e.g. the HTTP protocol, cooperate with application programs on the respective devices.

Upon a data transfer, the data to be transferred are first prepared by the external data processing apparatus according to the above-sketched communication protocol stack. For this purpose, the useful data are provided with protocol data by each of the selected protocols of the communication protocol stack before they are finally transferred. By means of the security protocol, which is inserted in the communication protocol stack at a suitable place, the useful data (possibly including the protocol data of higher layers) are secured cryptographically, for example encrypted. The portable end device according to the invention handles the received, prepared data—in reverse order—according to the communication protocols employed for data transfer, by the respective protocol data being removed or processed such that the useful data are finally present on the end device. A handling according to the security protocol then means for example a decryption of the encrypted data.

NOM According to the invention, only precisely that part of the handling of the data is thus carried out in the secured data handling environment of the end device for which this is necessary in order to manage the securely received data (or the useful data) securely in the end device as well, namely the handling of the received data according to the security protocol. In this manner, the resources to be reserved for this purpose in the secured data handling environment, for example memory, computing capacity and stored executable code, can be kept small and efficient. No handling operations that are not necessarily security-relevant are carried out in the secured data handling environment, so that the secured data handling environment remains reserved and ready for use for actually security-relevant data and applications. Likewise, the present invention makes it possible to set up the end device or its secured data handling environment as the end point of a cryptographically secured data transfer, without having to resort to security functionalities of a portable data carrier integrated into the end device, with its inherently limited resources. Security-relevant received data can be handled and stored directly in the secured data handling environment of the end device.

On the part of the end device according to the invention, this means in particular that in the secured data handling environment only those communication protocols of the communication protocol stack must be implemented that are necessary for a secured handling of the data in the secured data handling environment. This is primarily the security protocol itself. Communication protocols below the security protocol can be processed safely in the unsecured data handling environment. This keeps the secured data handling environment free from not necessarily security-relevant applications.

The invention thus makes possible a simple and efficient, but simultaneously completely secured handling of data received from a portable end device over a communication network within the framework of a secured data transfer. The functionality of the end device can thereby also be increased in secured fashion, for example by receiving security-relevant authentication applications and/or authentication data. Finally, a secured administration of the end device becomes possible.

According to a preferred embodiment of the invention, the data are transferred from the unsecured data handling environment to the secured data handling environment before the handling according to the security protocol. In this manner there is reliably prevented an unauthorized access to the data upon and/or after the handling according to the security protocol, e.g. upon or after the decryption of the hitherto encrypted data.

Preferably, the handling of the data according to the communication protocols of the communication protocol stack above the security protocol is also effected in the secured data handling environment, in order for the useful data not to be accessible in the unsecured data handling environment at any time. This is necessary in particular when the useful data are themselves security-relevant data. Therefore, the corresponding communication protocols above the security protocol are possibly not implemented exclusively in the secured data handling environment. There can be present a further implementation of said communication protocols in the unsecured data handling environment, which serves there for handling non-security-relevant, insecurely transferred data. Other applications are conceivable by which the data, after they have been handled in the secured data handling environment according to the security protocol, for example in order to check an authorization of a user to further process the data, are processed further in the unsecured data handling environment, for example by playing the data as video/audio data (“streaming media”) using a playback application. Here, the data are thus handled exclusively according to the security protocol in the secured data handling environment.

Preferably, there is employed such a security protocol that supports a unilateral and/or mutual authentication of the two communication partners, i.e. for example an authentication of a server to an end device and optionally also an authentication of the end device or of a user of the end device to the server. Such an authentication is effected for example by means of certificates. For producing a suitable certificate on the part of the user or of the end device there is required a (confidential) authentication key. However, an authentication of a user or end device to the server can also be effected directly via an authentication key or via a password. Further, an employed security protocol preferably supports an encryption of data to be transferred. For this purpose there can for example be negotiated between the communication partners a session key or transport key valid for a data transfer session, for example by means of the Diffie-Hellman method. This temporary transport key then serves for encryption of the data, for example by means of a symmetric encryption method such as DES or ABS.

The transport key and the authentication key can be stored in the secured data handling environment of the end device, where they are protected from unauthorized accesses. The authentication key is subject to special security requirements, because it is security-relevant in connection with not only one particular data transfer, but every data transfer. For if said authentication key is lost, it is possible for the wrongful owner of the same to simulate the identity of the user or end device. Therefore, it is advantageous to store the authentication key on a secured portable data carrier which is integrated into the secured data handling environment of the end device. For example, the data carrier can be accessed exclusively from the secured data handling environment of the end device. Such suitable secure data carriers are for example (U)SIM mobile communication cards or secure multimedia cards.

According to a preferred embodiment, there is employed as a security protocol a communication protocol that is arranged at a place in the communication protocol stack that makes it possible to secure the data only to precisely the extent as required by the particular application. That is, the security protocol preferably lies between the Transport Layer and the Application Layer of the TCP/IP reference model, such as for example the SSL/TLS security protocol. When the Application Layer is represented by several communication protocols, it is also possible that the security protocol is arranged at a suitable place between said communication protocols, i.e. within the Application Layer.

Below the security protocol, in the Network or Internet Layer or in the Transport Layer of the TCP/IP reference model, there are preferably employed upon a data transfer the IP protocol or the TCP protocol. Suitable communication protocols of the Application Layer, which are usually arranged above the security protocol, are for example the HTTP protocol or the SOAP protocol.

According to a further preferred embodiment, the method according to the invention makes it possible that for a data processing apparatus there is established a secured data communication connection into the secured data handling environment of the end device. That is, a cryptographically secured data communication connection between the data processing apparatus and the end device ends in the secured data handling environment of the end device. A suitable security protocol for this purpose is for example an SSH protocol.

For configuring the secured data handling environment of the end device there are several technologies available, for example the described TrustZone® technology, which provides a secured data handling environment also on the hardware level. By means of different known virtualization technologies there can likewise be realized a secured data handling environment, partly on the hardware level or only on a software basis. A concrete realization is only relevant to the subject matter of the present invention insofar as there must be guaranteed a secured data handling environment which supports a secured storage of data and a secured execution of security-relevant applications in the secured data handling environment. That is, it must be possible to reliably prevent an access to data stored in the secured data handling environment and/or an influencing of applications executed in the secured data handling environment from the unsecured data handling environment.

Portable end devices that can be configured according to the invention are for example so-called handhelds, in particular mobile radio end devices or PDAs, as well as game consoles, multimedia playback devices or so-called netbooks and the like.

The invention will hereinafter be described by way of example with reference to the attached FIGURE. The latter shows schematically the course of a preferred embodiment of the method according to the invention.

From a data processing apparatus 100 in the form of an Internet server there are transferred in a step S0 useful data (DATA) 70 over the Internet 200 to a portable end device 10, which is depicted here as a mobile radio end device. Instead of the Internet server 100 there can be used arbitrary other data processing devices that are set up to transfer data over a communication network, e.g. the Internet 200 and/or a mobile communication network (not shown). The portable end device 10 can also appear in different embodiments. All types of handhelds, i.e. in particular PDAs and the like, but also game consoles, multimedia playback devices or netbooks and similar portable devices can be understood to be portable end devices 10 within the scope of the present invention.

To make possible a transfer of the useful data 70 over the Internet 200, the useful data 70 are prepared according to suitable communication protocols 22, 24, 26, 32, 34 of the TCP/IP protocol stack. For this purpose, protocol data are added to the useful data 70 respectively by a communication protocol of a layer of the communication protocol stack so that the service to be provided on the corresponding layer by the communication protocol can be carried out in controlled fashion. In the described embodiment, the useful data 70 are prepared on the Application Layer according to the HTTP protocol 34 as the HTTP page 70A, which can be displayed after receipt on the end device 10 for example by a web browser (not shown). Other communication protocols beside or over HTTP are likewise possible, for example the SOAP protocol.

To make possible a secured data transfer in the sense that the useful data 70 cannot be tampered with unnoticed or intercepted by unauthorized third parties during the data transfer, the data 70A are secured by means of a security protocol 32, here specifically by means of SSL/TLS. In this manner the identity of the transmitter, i.e. of the server 100, can also be ascertained without any doubt by the receiver, i.e. the end device 10, that is, an authentication of the server 100 to the end device 10 is supported. An authentication of the end device 10 to the server 100 by means of a suitable certificate is also provided. The resulting, secured data 70B are supplemented by further protocol data to be able to be transferred. Once through the TCP protocol 26 of the Transport Layer, once through the IP protocol 24 of the Internet Layer. There result the data 70C and 70D, respectively. In order for the data 70D to be finally transferred via a radio interface to the end device 10, a further communication protocol, this time of the Network Access Layer, is necessary, for example, WCDMA, which makes possible a concrete, physical data transfer of the data 70E, for example over a UMTS mobile communication network.

The end device 10 receives the thus prepared data 70E in step S1 via a data communication interface 12, in this concrete case an antenna.

In the end device 10 there are respectively configured an unsecured data handling environment 14 and a secured data handling environment 16. The unsecured data handling environment 14 is controlled by a usual operating system (not shown) and has computing and memory capacities in order to store data and execute applications on the end device 10 in the known way. For example, the data 70E are stored after receipt by the end device 10 in the unsecured data handling environment 14 and, as hereinafter described in detail, handled by the data handling device 20.

The secured data handling environment 16 is also set up such that data can be stored and applications executed therein. For example, the security data handling device 30 handles the data 70B therein, as described hereinafter. Unlike the unsecured data handling environment 14, the secured data handling environment 16 is specially secured against unauthorized access, in particular from the unsecured data handling environment 14. That is, a specially set up security operating system (not shown) manages the secured data handling environment 16. The control device 40 controls as part of the security operating system the access to the resources of the secured data handling environment 16, i.e. in particular the data 70B, 70A stored therein and the applications 30 implemented therein. Further, the secured data handling environment 16, in the described embodiment, is already separated from the unsecured data handling environment 14 on the hardware level, meaning in particular that there are present in the secured data handling environment for example its own, separate storage areas 50 which are only accessible from the secured data handling environment 16. Further hardware-based security measures are possible, for example separate buses, processors and periphery together with the associated separate drivers. Such a security architecture already created on the hardware level and providing unsecured 14 and secured data handling environments 16 is implemented for example on processors from the company ARM and known as TrustZone® technology. Alternatively, secured data handling environments 16 can also be obtained by means of different known virtualization technologies, then usually on a software basis.

To meet especially high security requirements, the secured data handling environment 16 additionally comprises, in the shown embodiment, a secured portable data carrier 60 integrated into the end device 10, here a (U)SIM mobile communication card. Data 62 stored therein are thus secured against unauthorized access in double fashion. Just like the storage area 50, the secured data carrier 60 is accessible exclusively from the secured data handling environment 16.

The data 70E received by the end device 10 are now first handled according to the communication protocols below the security protocol SSL/TLS 32 by the data handling device 20 in the unsecured data handling environment 14. In so doing, in particular the protocol data that were added to the useful data 70 according to the WCDMA protocol 22, the IP protocol 24 and the TCP protocol 26 are removed again successively in the steps S2, S3 and S4. For this purpose, the data handling device 20 comprises implementations of the corresponding protocols 22, 24, 26. The handling of the data 70E by the data handling device 20, which as a result generates the data 70B, thus in no way burdens the secured data handling environment 16, either with regard to memory resources or with regard to computing capacity. It can further be avoided that the communication protocols 22, 24, 26 below the security protocol 32 are present as executable code in the secured data handling environment 16.

The data 70B, which correspond to the useful data 70 encrypted by means of the security protocol 32 and prepared according to an application protocol 34, are transferred in the step S5 by means of the control device 40 from the unsecured data handling environment 14 to the secured data handling environment 16. For this purpose there can be employed suitable mechanisms of inter-process communication (IPC). In the simplest case, the control device 40 can permit the security data handling device 30, or an auxiliary application associated with said device (not shown), to access a storage area of the unsecured data handling environment 14 in which the data handling device 20 has stored the data 70B, and to transfer the data 70B to the secured data handling environment.

In the step S6 the security data handling device 30 handles the data 70B by means of an implementation of the SSL/TLS protocol 32. Before the transfer of the data of 70E to the end device 10 there was effected a mutual authentication between the end device 10 and the server 100 by which the two communication partners verified the other side's respective certificates. The certificate of the end device 10 was created by means of an authentication key 62 which is stored on the secured portable data carrier 60 in especially secure fashion. The server 100 and the end device 10 then negotiated, for encrypting the data 70A, a transport key 52 which was stored in the end device 10 in the memory 50 of the secured data handling environment 16. The server 100 thereupon encrypted the data 70A using the transport key 52 according to a symmetric encryption method, for example DES or AES, and obtained the encrypted data 70B, which were then, as described hereinabove, prepared by the server according to the further communication protocols 26, 24, 22 and transferred to the end device 10. The data 70B thus encrypted and already mostly “unpacked” again are now decrypted, again using the transport key 52, in the secured data handling environment 16 of the end device 10 by means of the SSL/TLS implementation, resulting in the data 70A only handled according to the HTTP protocol 34.

In step S7 and possibly further steps (not shown), the data 70A are handled as now unencrypted data 70A by means of suitable applications 34 in the secured data handling environment 16. However, the data 70A are further secured by the fact that they can be stored in the secured data handling environment 16 and therefore processed only by secured applications 32, 34 implemented therein.

The described method possesses numerous applications. It becomes possible for example to transfer security-relevant applications, such as a home banking client (not shown), in secured fashion, as described hereinabove with reference to the useful data set 70, to the end device 10 and to install them there in the secured data handling environment 16 by means of the security operating system. Thus, a secure check of the authenticity of the other side, i.e. of the home banking server, becomes possible for a user of the end device 10 within the framework of a home banking application, through the fact that a server certificate check can take place in the secured data handling environment 16. Further, the secure data handling environment 16 provides secured storage areas for security-relevant data, such as PIN, TAN, cryptographic keys and the like, which are transmitted, secured end-to-end on the application level, for example as described hereinabove by means of a securing by means of the SSL/TLS security protocol above the TCP protocol, from the secured data handling environment 16 to the home banking server.

A second application relates to the secured administration of the end device 10. In the described way an administration module (not shown) can be installed in the secured data handling environment 16 of the end device 10 in secured fashion. Said administration module can then perform the administration and the device management of the end device 10, for example according to the known specifications of the Open Mobile Alliance (OMA DM or OMA SCWS). Because the data required for the administration were transferred to the secured data handling environment 16 in secured fashion, integrity and confidentiality is already guaranteed by the transport protection. In this manner it is possible to improve the reliability and security of this and similar OTA management systems.

Finally, the described method is also suited quite generally for establishing a cryptographically secured data communication connection from an external data processing apparatus, e.g. an Internet server, to an end device, for example a mobile radio end device, whereby the data communication connection ends directly on the end device, i.e. in a secured data processing environment of the end device. As a security protocol there can be employed here e.g. an SSH protocol. Via a thus established, secured data communication connection it is also possible to carry out for example a servicing or an update of the end device easily and securely, without having to resort to security functionalities of a secured portable data carrier integrated into the end device.

1-14. (canceled)

15. A method for using a portable end device by which data that are prepared by an external data processing apparatus according to a communication protocol stack that cryptographically secures the data according to a security protocol of the communication protocol stack are received, comprising the steps:
handling the received data in an unsecured data handling environment of the end device according to communication protocols of the communication protocol stack that are below the security protocol in the communication protocol stack; and
handling the received data in a secured data handling environment of the end device at least according to the securit protocol.

16. The method according to claim 15, wherein the data handled according to the communication protocols below the security protocol in the communication protocol stack are transferred from the unsecured data handling environment to the secured data handling environment before the handling according to the security protocol.

17. The method according to claim 15, wherein the data are also handled in the secured data handling environment of the end device according to the communication protocols above the security protocol in the communication protocol stack.

18. The method according to claim 15, including using that as a security protocol a communication protocol which supports a unilateral and/or a mutual authentication and/or an encryption of data.

19. The method according to claim 15, including storing in the secured data handling environment of the end device a temporary transport key employed according to the security protocol and/or an authentication key employed according to the security protocol.

20. The method according to claim 15, wherein the secured data handling environment of the end device comprises a secured portable data carrier on which the authentication key is stored.

21. The method according to claim 15, wherein the data are handled according to a communication protocol stack wherein the security protocol is arranged between a communication protocol of the Transport Layer of the TCP/IP reference model and a communication protocol of the Application Layer of the TCP/IP reference model.

22. The method according to claim 21,wherein the data are handled according to a communication protocol stack wherein the IP protocol and the TCP protocol are employed below the security protocol, and/or the HTTP protocol and/or the SOAP protocol are employed above the security protocol.

23. The method according to claim 15, wherein as a security protocol there is employed an SSL/TLS protocol.

24. The method according to claim 15, wherein, for the data processing apparatus, establishing a secured data communication connection into the secured data handling environment of the end device.

25. A portable end device, comprising:
a data communication interface and an unsecured data handling environment for unsecured handling of data and a secured data handling environment for secured handling of data;
a data handling device in the unsecured data handling environment which is arranged to handle data that are received via the data communication interface and prepared according to a communication protocol stack whereby the data are cryptographically secured according to a security protocol, according to communication protocols below the security protocol in the communication protocol stack in the unsecured data handling environment; and
a security data handling device in the secured data handling environment which is arranged to handle the data at least according to the security protocol in the secured data handling environment.

26. The end device according to claim 25, wherein the secured data handling environment is arranged in the end device by an ARM TrustZone® technology or by virtualization.

27. The end device according to claim 25, wherein the data handling device and the security data handling device are configured to carry out the method according to claim 15.

28. The end device according to claim 25, wherein the end device is configured as a handheld device or PDA, or as a game console, multimedia playback device or netbook.
